(19) United States
(12) Patent Application Publication
(10) Pub. No.: US 2008/0136621 A1
(43) Pub. Date: Jun. 12, 2008

(54) METHODS AND APPARATUS FOR WLAN MANAGEMENT USING RF TAGS

(75) Inventors: Ajay MALIK, San Jose, CA (US); Puneet BATTA, Santa Clara, CA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/608,100

(22) Filed: Dec. 7, 2006

(51) Int. Cl. H04Q 7/00; G08B 13/14; G08B 1/08; H04Q 7/24

(52) U.S. Cl. 340/539.1; 340/572.1; 340/10.1; 370/338

(57) ABSTRACT

An access port has an RF tag associated therewith (e.g., physically incorporated into the access port), wherein the RF tag includes configuration information. A mobile unit having an RF tag reader associated therewith sends a probe request and reads the configuration information from the RF tag. The RF tag may include, for example, information traditionally incorporated into an IEEE 802.11 probe response or beacon. The tag may include, for example, non-real-time configuration information, such as capabilities of the access port, data rates, and the like.

### TECHNICAL FIELD

The present invention relates generally to radio frequency identification (RFID) systems, wireless local area networks (WLANs), and other such networks incorporating RF tags, and, more particularly, to methods of managing mobile units and access points in a WLAN system.

### BACKGROUND

There has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards). Due the size of modern wireless networks, it has become difficult to plan, monitor, manage, and troubleshoot such systems. The number of mobile units and associated access ports, as well as the number of RFID readers and associated antennae, can be very large in an enterprise. As the number of components increases, the management and configuration of those components becomes complicated and time-consuming.

At the same time, radio frequency identification (RFID) systems have achieved wide popularity in a number of applications, as they provide a cost-effective way to track the location of a large number of assets in real time. In large-scale application such as warehouses, retail spaces, and the like, many types of tags may exist in the environment. Likewise, multiple types of readers, such as RFID readers, active tag readers, 802.11 tag readers, Zigbee tag readers, etc., are typically distributed throughout the space in the form of entryway readers, conveyer-belt readers, mobile readers, etc., and may be linked by network controller switches and the like.

Accordingly, it is desirable to provide improved methods and systems for managing components in a large WLAN system. Furthermore, other desirable features and characteristics of the present invention will become apparent from the subsequent detailed description and the appended claims, taken in conjunction with the accompanying drawings and the foregoing technical field and background.

### BRIEF SUMMARY

In accordance with the present invention, an access port has an RF tag associated therewith (e.g., physically incorporated into the access port), wherein the RF tag includes configuration information, and wherein the access point is configured to send a probe response in response to a probe request. A mobile unit having an RF tag reader associated therewith sends a probe request and reads the configuration information from the RF tag. The RF tag may include, for example, information traditionally incorporated into an IEEE 802.11 probe response or beacon. In one embodiment, the tag includes non-real-time configuration information, such as capabilities of the access port, data rates, and the like.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention; and

FIG. 2 is a conceptual illustration of an access port and mobile unit in accordance with one embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates to systems and method for managing WLAN components using RF tags. In one embodiment, for example, one or more access points or access ports include an RFID tag that contains information that would typically be included in that access point's probe response (e.g., an 802.11 probe response). Using an RFID reader, a mobile unit scans for such RFID tags and reads the configuration data contained therein. In this way, configuration occurs faster, and co-channel interference is reduced.

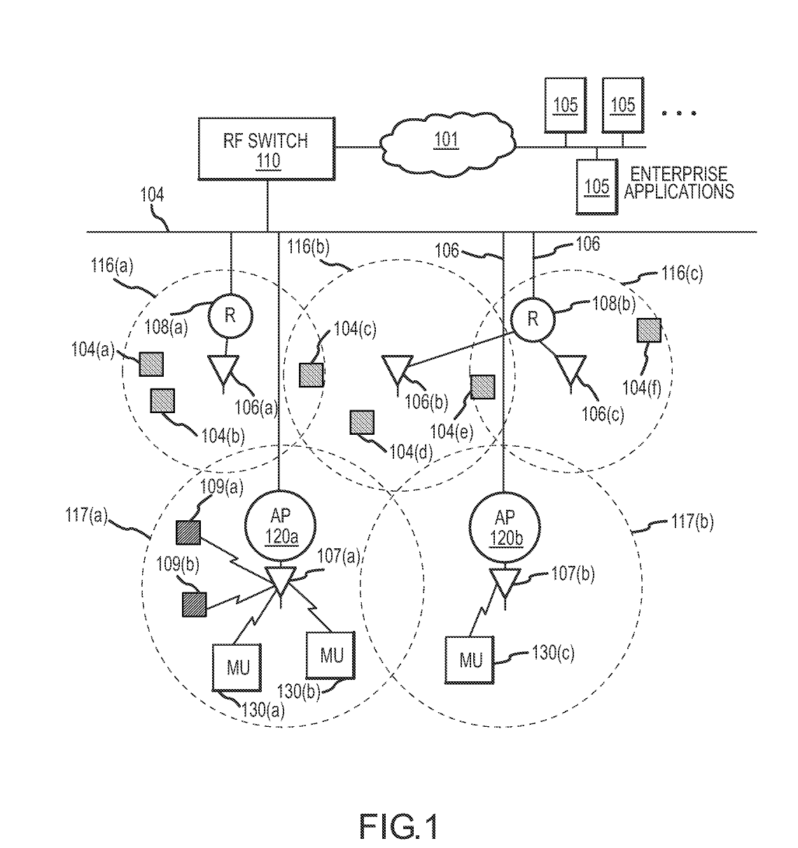

Referring to FIG. 1, in an example system useful in describing the present invention, a switching device 110 (alternatively referred to as an “RF switch,” “WS,” or simply “switch”) is coupled to a network 101 and 104 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). This wireless connection involves MUs 130 periodically scanning (using “active scans”) for nearby APs 120, then receiving a probe response (e.g., an 802.11 probe response) from those APs.

APs 120 suitably communicate with switch 110 via appropriate communication lines 106 (e.g., conventional Ethernet lines, or the like). Any number of additional and/or intervening switches, routers, servers and other network components may also be present in the system.

A number of RF tags (“RFID tags,” or simply “tags”) 104, 107 may be distributed throughout the environment. These tags, which may be of various types, are read by a number of RFID readers (or simply “readers”) 108 having one or more associated antennas 106 provided within the environment. The term “RFID” is not meant to limit the invention to any particular type of tag. The term “tag” refers, in general, to any RF element that can be communicated with and has an ID (or “ID signal”) that can be read by another component. Readers 108, each of which may be stationary or mobile, are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

RF switch 110 can support any number of tags that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active, passive, or semi-active. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1). An antenna 107 coupled to an AP 120 may also communicate directly with RFID tags (such as tags 109(a) and 109(b), as illustrated).

It is not uncommon for RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

As described in further detail below, switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

RF switch 110 allows multiple read points 116 to be logically combined, via controller 102, within a single read point zone (or simply “zone”). For example, referring to FIG. 1, a read point zone 120 may be defined by the logical union of read points 116(a), 116(b), and 116(c). Note that the read points need not overlap in physical space, and that disjoint read points (e.g., read point 116(d)) may also be included in the read point zone if desired. In a preferred embodiment, antennas (i.e., read points defined by the antennas) can be arbitrarily assigned to zones, regardless of whether they are associated with the same reader. That is, referring to FIG. 1, antennas 106(b) and 106(c), while both associated with reader 108(b), may be part of different zones. Controller 102 then receives all tag data from readers 108 via respective data links 103 (e.g., wired communication links, 802.11 connections, or the like), then aggregates and filters this data based on zone information. The read point zones are suitably preconfigured by a user or administrator. That is, the user is allowed to access controller 110 and, through a configuration mode, specify a set of read points that are to be included in a particular zone. RF switch 110. includes a cell controller (CC) and an RFID network controller (RNC), In general, the RNC includes hardware and software configured to handle RFID data communication and administration of the RFID network components, while the CC includes hardware and software configured to handle wireless data (e.g., in accordance with IEEE 802.11) from the mobile units and access ports within wireless cells. In one embodiment, RF switch 110 includes a single unit with an enclosure containing the various hardware and software components necessary to perform the various functions of the CC and RNC as well as suitable input/output hardware interfaces to networks 101 and 104.

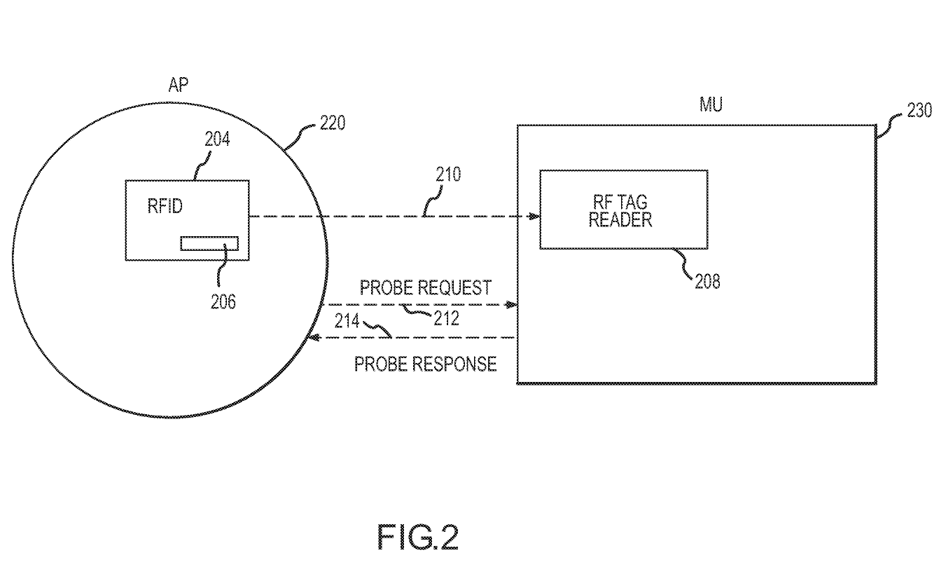

Referring to FIG. 2, an RF tag 204 is attached to, incorporated into, or otherwise associated with AP 220. RF tag may, for example, be attached to the external housing of AP 220, or may be located within AP 220, such as on a PCB or other internal component of AP 220.RF tag 204 includes configuration information 206 which, as discussed in detail below, relates to the state of the network (not shown) and/or the state or capabilities of AP 220. RF tag 204 may be an active tag, passive tag, or semi-active tag, and may have associated access privileges—for example, read-only for MUs, and read/write for AP 220 or other networked components.

An MU 230 includes an RF reader 208 incorporated into, attached to, or otherwise associated therewith. RF reader 208 may be configured to read active tags, passive tags, and/or semi-active tags, and in an exemplary embodiment is incorporated directly into MU 230.

During operation, MU 230 periodically scans its environment (within the range of its antenna or antennas, which are not illustrated) for the presence of APs within range. That is, MU performs an active scan, sending out a probe request 212. The content of this probe request may vary, depending upon the nature of the network. In one embodiment, for example, probe request 212 is comparable to an IEEE 802.11 probe request, which are known in the art.

When an appropriately-configured AP 220 receives probe request 212, it sends out a probe response 214. AP 220 also sends out configuration data 206 contained within RF tag 204 (via RF signal 210), which is received and processed by MU 230. In one embodiment, probe response 214 includes an instruction for MU 230 to receive configuration data from RF tag 204.

The probing and response preferably occurs on a frequency that is not used for standard data traffic between MU 230 and AP 220. For example, in one embodiment, probing occurs over a set of frequencies that are not used by conventional IEEE 802.11 devices. In this way, probing occurs in parallel to data traffic, allowing more frequent scanning, and allowing faster selection of roam candidates.

Configuration data 206 includes any suitable set of data or information related to the state of the network and/or the state of AP 220. This information might include the SSID of the network, the supported data rates on that network, the country of operation, the type of encryption and authentication supported on the network, and the transmission power level. Configuration data 206 may, for example, include any suitable subset of the 802.11 probe response data. In a particular embodiment, configuration data 206 is substantially the same as the 802.11 probe response data. In this regard, the configuration data 206 within RF tag 204 may be automatically updated by AP 220 (or another entity) when the state of AP 220 and/or the network changes.

In a further embodiment, substantially non-real-time components of an 802.11 AP beacon can be stored in configuration data 206. In one embodiment, for example, configuration data 206 includes substantially non-real-time information usually placed in an 802.11 beacon, such as information related to the capabilities of AP 220, etc. In such an embodiment, probe response 214 still includes substantially real-time information, such as timing information, DTIM counters, etc. Real time information might include time-stamps, count of the number of associated mobile units, and/or network utilization counters.

It should be appreciated that the example embodiment or embodiments described herein are not intended to limit the scope, applicability, or configuration of the invention in any way. For example, these methods may be used in connection with standard barcode readers and the like. In general, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for associating a mobile unit with an access port in a wireless network, the method comprising:
providing a RF tag coupled to the access port, wherein the RF tag includes configuration data;
scanning for RF tags in the vicinity of the mobile unit; and
reading the configuration data from the RF tag.

2. The method of claim 1, wherein reading the configuration data includes reading information related to configuration of the access port.

3. The method of claim 1, wherein reading the configuration data includes reading information related to configuration of the wireless network.

4. The method of claim 1, wherein reading the configuration data includes reading information that at least partially comprises a probe response from the access port.

5. The method of claim 4, wherein the configuration data comprises at least a portion of an IEEE 802.11 probe response.

6. The method of claim 1, further including updating the configuration data on the RF tag.

7. The method of claim 1, wherein the access port is configured to send a probe response that includes an instruction to the mobile unit to perform the step of reading the configuration data from the RF tag.

8. The method of claim 7, wherein the configuration data includes a substantially non-real-time component of an IEEE 802.11 beacon.

9. A wireless network system comprising:
an access point having an RF tag associated therewith, the RF tag including configuration information, the access point configured to send a probe response in response to a probe request; and
a mobile unit having an RF tag reader associated therewith, the mobile unit configured to send the probe request and to read the configuration information from the RF tag.

10. The system of claim 9, wherein the configuration data includes information related to configuration of the access port.

11. The system of claim 9, wherein the configuration data includes information related to configuration of the wireless network.

12. The system of claim 9, wherein the configuration data comprises a subset of an IEEE 802.11 probe response.

13. The system of claim 9, wherein the access port is configured to update the configuration data on the RF tag.

14. The system of claim 9, wherein the probe response includes an instruction to the mobile unit to perform the step of reading the configuration data from the RF tag.

15. The system of claim 9, wherein the probe response includes at least one non-real-time parameter of an 802.11 beacon.

16. An access port having an RF tag coupled thereto, wherein the RF tag includes configuration data related to the access port.

17. The access port of claim 16, wherein the configuration data includes a subset of an IEEE 802.11 probe response.

18. The access port of claim 16, wherein the access port is configured to send a probe response that includes an instruction to read the configuration data from the RF tag.

19. The access port of claim 16, wherein the RF tag is selected from the group consisting of active tags, passive tags, and semi-active tags.
